(19) United States
(12) Patent Application Publication
(10) Pub. No.: US 2010/0037409 A1
(43) Pub. Date: Feb. 18, 2010

(54) CLEANING DEVICE FOR SCANNER

(75) Inventors: Liu-Zhi Yang, Suzhou (CN); Ying-Qi Zhu, Suzhou City (CN)

Correspondence Address: COVENANT IP CONSULTING CO., P.O. BOX 34-306 TAIPEI CITY, TAIPEI, 10499, TW

(73) Assignee: QISDA (SUZHOU) CO.,LTD, Suzhou (CN)

(21) Appl. No.: 12/509,517

(22) Filed: Jul. 27, 2009

(30) Foreign Application Priority Data
Aug. 15, 2008 (CN) 200810021164.7

(51) Int. Cl. B08B 1/00

(52) U.S. Cl. 15/210.1

(57) ABSTRACT

A cleaning device for scanner includes a handhold portion and a cleaning portion including a window cleaning surface. The handhold portion and the cleaning portion are fixed together, and the thickness of the handhold portion is larger than that of the cleaning portion. The cleaning portion further includes a loading body. The loading body can be a hard or flexible flat board that has a first end, which is fixed with the handhold portion, and a second end. The cleaning process of the cleaning device for the scanner is simple. The window cleaning surface can be replaceable or not and is cheap when manufactured, suitable for being used in any scanner having an immovable scanning module relative to its housing, and more practically, for cleaning the glass window and roller of small size and any portable scanner, so as to maintain scanning quality and scanning precision.

This application claims the benefit of Taiwan application Serial No. 200810021164.7, filed Aug. 15, 2008, the subject matter of which is incorporated herein by reference.

### BACKGROUND OF THE INVENTION

1. Field of the Invention

The invention relates in general to a peripheral device for scanner, and more particularly to a cleaning device used for cleaning important inner components in a small size scanner.

2. Description of the Related Art

Scanner is a widely-used electrical input device nowadays. It includes a scanning module and a mechanical transmission portion. A sheet-fed scanner has simple structure and therefore can be miniaturized to become a portable input tool. A contact image sensor (CIS) is usually fixed to the housing of the sheet-fed scanner. The document to be scanned moves relatively to the housing of the scanner so that the scanner can scan the document. This scanning way is especially suitable for small size and portable scanners, for scanning small documents such as photos, receipts, business cards, cards, etc.

FIG. 1A illustrates a conventional portable scanner 10 when the scanner scans a document. The portable scanner performs scanning by using a CIS which is immovable relative to the housing 100 of the scanner 10. The document 103 to be scanned is flatly place on the document tray 101 at the paper inlet 102. The document 103 moves along the direction shown in FIG. 1A when the mechanical transmission portion of a paper feeding mechanism functions. FIG. 1B is a cross-sectional view of the portable scanner 10 in FIG. 1A when the scanner scans the document. A CIS scanning module 105 is fixed inside the housing 100 of the scanner 10 and above the document 103 to be scanned. The document 103 is driven by a roller 106 of the paper feeding mechanism. When scanning is performed, the document 103 enters the scanner 10 through the paper inlet 102 and exits through a paper outlet 108. The CIS scanning module 105 obtains the scanning data of the scanned document 103 through a glass window 107. The portable scanner 10 can scan many different kinds of documents. Some dust, liquid or other adhesive substances are inevitably attached to the document. For example, considerable dust is attached to the surface of photos because of the adhesive properties. The dust and adhesive substances might be brought to the surface of the glass window 107 of the CIS scanning module 105 along with the document when the scanner scans the document. The dust or the adhesive substances attached to the glass window 107 are hard to be removed. The glass window is an important component of the scanner to obtain the image. The dust or the adhesive substances may block the light of the scanning components. As a result, the document can not be accurately scanned at the location of the dust or adhesive components. For example, the obtained image would show an unusual line at that location. Because the scanning module is fixed to the housing of the scanner, it is difficult to clean the glass window. Also, dust and adhesive substances are easily attached to the roller driving the document, which affects the feeding of the document.

### SUMMARY OF THE INVENTION

The invention is directed to a simple cleaning device for easily cleaning the important inner components of the scanner. The cleaning device is for cleaning the substances on the glass window of the scanner which block the scanning light. The cleaning device provides excellent cleaning performance and is easy to use.

According to the present invention, a cleaning device for scanner is provided. The cleaning device includes a handhold portion and a cleaning portion. The cleaning portion has a window cleaning surface. The handhold portion and the cleaning portion are fixed together. The thickness of the handhold portion is larger than that of the cleaning portion.

More specifically, in the cleaning device for scanner, the handhold portion is connected with one end of the cleaning portion. The cleaning portion includes a loading body and a window cleaning sheet. The loading body is a hard or flexible flat board having a first end and a second end. The first end of the loading body is fixed with the handhold portion. The window cleaning sheet is fixed on a first surface of the loading body to form the window cleaning surface. The length of the window cleaning sheet is equal to or larger than that of the distance between the paper inlet or the paper outlet and the glass window of the scanner. The window cleaning sheet includes at least one of a soft cleaning cloth, a cleaning swab and a cleaning fiber. Furthermore, the window cleaning sheet can be a planar cleaning object and adhered to one surface of the loading body.

In another example, the cleaning device for the scanner includes the handhold portion immovably disposed on one end of the cleaning portion. The cleaning portion includes a soft window cleaning sheet. The window cleaning surface is on a first surface of the soft window cleaning sheet. The cleaning portion further includes a soft base. The soft window cleaning sheet of the window cleaning surface is immovably disposed on the upper surface of the soft base. The thickness of the handhold portion is larger than that of the cleaning portion.

The cleaning device for scanner mainly includes the handhold portion and the cleaning portion. The handhold portion is for a user to hold the cleaning device when the user performs cleaning. The appearance of the cleaning device can be adjusted according to the style of the product. The thickness of the handhold portion is generally larger than that of the cleaning portion. As a result, the handhold portion is always outside the paper inlet or the paper outlet of the scanner and easy to be held. The cleaning portion is used for cleaning the glass window of the scanner. The cleaning portion preferably includes a hard or flexible flat board to be the loading body. And, a window cleaning sheet is fixed on the surface of the loading body, so as to form the cleaning portion. The loading body and the handhold portion are preferably formed integrally and made of engineering plastic, such as polymer materials. The loading body is used for disposing and fixing the window cleaning sheet. The width and the length of the loading body can be determined according to the scanner to be cleaned. Generally speaking, the width should allow the cleaning portion of the cleaning device to slide laterally while the cleaning process is performed. The length should allow the handhold portion to be outside the scanner and the window cleaning sheet to reach the glass window. The window cleaning sheet can be a soft cleaning cloth, a cleaning swab or cleaning fiber. The fixing can be done by glue, double-sided adhesive tapes, etc.

When the cleaning device according to the above examples cleans the scanner, the user holds the handhold portion, and one end of the cleaning portion is inserted into the paper outlet of the scanner. The window cleaning sheet of the cleaning portion is opposite to the glass window of the scanning module. At this moment, the cleaning device is moved laterally, so that the window cleaning sheet cleans the entire glass window along the extending direction of the glass window, which provides excellent cleaning performance for the glass window. When a roller cleaning function is needed, a roller cleaning sheet is fixed on another surface of the loading body of the cleaning cloth. The roller cleaning sheet is on a tangent line of the roller and contacts the roller when inserted into the scanner. After the scanner is turned on and the roller rotates, the roller cleaning sheet cleans the roller.

In order to insert the cleaning portion of the cleaning device into the scanner more easily, the loading body of the cleaning portion is preferably wedge-shaped that the thickness of the second end of the loading body is less than that of the first end of the loading body.

In another example, the cleaning device for scanner includes a soft cleaning portion. The handhold portion is fixed on one end of the cleaning portion, which is a soft sheet. The cleaning portion can include a soft base cloth on which a soft window cleaning sheet is fixed. Or, the cleaning portion can be formed by the soft window cleaning sheet directly. The present example can be used for cleaning the window when the scanner is turned on. A roller cleaning portion is disposed on another surface of the cleaning portion, for cleaning the roller that feed in the documents. The other end of the cleaning portion which is opposite to the handhold portion is inserted into the paper inlet of the scanner. The cleaning portion is fed into the scanner, and the window cleaning surface cleans the glass window of the scanning module. As the cleaning portion is fed in the scanner continuously, the handhold portion is blocked by the paper inlet and can not be fed in anymore. The roller cleaning sheet on the other end of the cleaning portion just contacts the roller. At this moment, the handhold portion is blocked by the paper inlet, so the cleaning portion can not move further. Accordingly, the roller cleaning sheet cleans the sliding roller.

The cleaning process of the cleaning device for scanner is simple and easy to perform. The window cleaning surface can be replaceable or not and is cheap when manufactured. The cleaning device is suitable for being used in any scanner that has an immovable scanning module relative to its housing, and more practically, for cleaning the glass window and roller of small size and portable scanner, so as to maintain scanning quality and scanning precision.

The invention will become apparent from the following detailed description of the preferred but non-limiting embodiments. The following description is made with reference to the accompanying drawings.

### BRIEF DESCRIPTION OF THE DRAWINGS

FIG. 1A illustrates a conventional portable scanner when the scanner scans a document;

FIG. 1B is a cross-sectional view of the portable scanner in FIG. 1A when the scanner scans the document;

FIG. 2 illustrates a cleaning device according to the first embodiment of the present invention;

FIG. 3A Illustrates the cleaning device applied to a scanner;

FIG. 3B is a cross-sectional view of the scanner and the cleaning device in FIG. 3A;

FIG. 4A illustrates a cleaning device according to the second embodiment of the present invention;

FIG. 4B is a back view of the cleaning device in FIG. 4A; and

FIGS. 5A˜5D illustrate the cleaning device according to the second embodiment of the present invention in operating states.

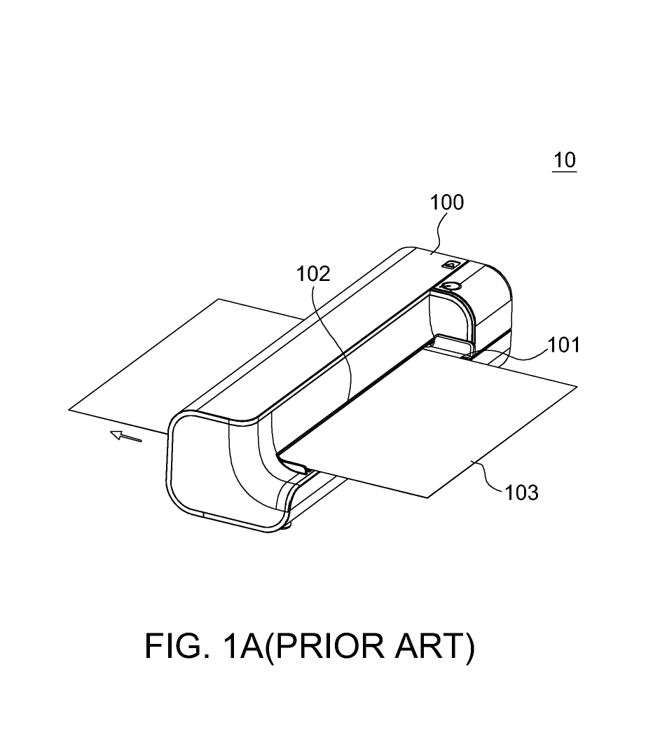

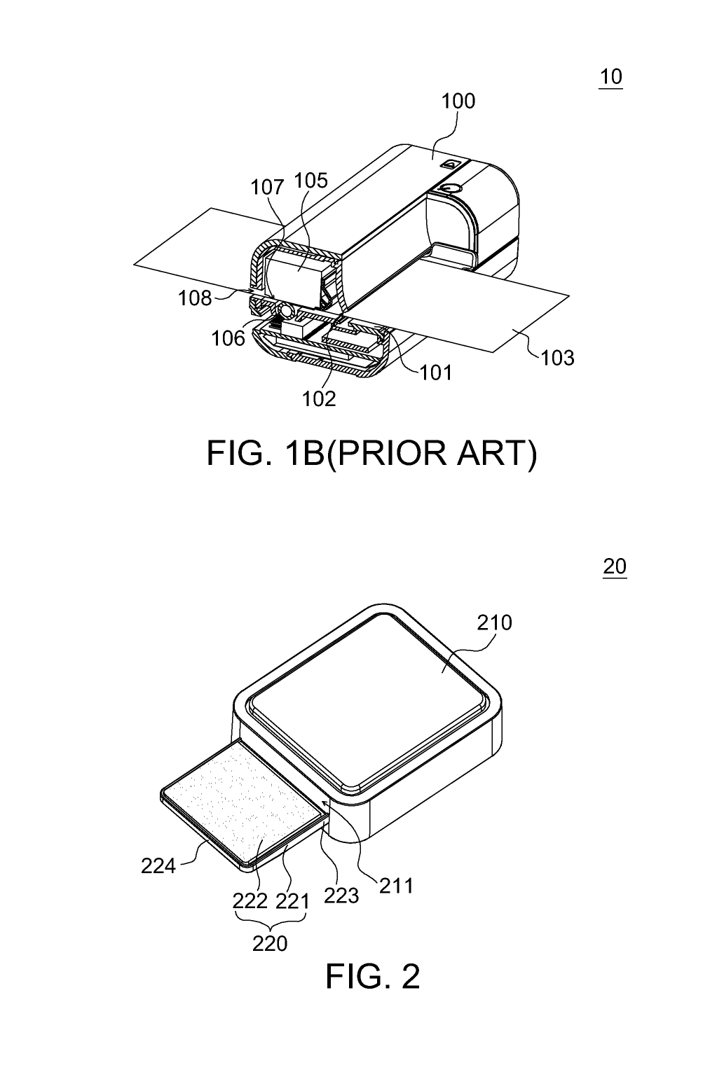

### DETAILED DESCRIPTION OF THE INVENTION

### First Embodiment

FIG. 2 illustrates a cleaning device according to the first embodiment of the present invention. The cleaning device 20 for scanner includes a handhold portion 210 and a cleaning portion 220. The cleaning portion 220 includes a loading body 221 and a window cleaning sheet 222. The handhold portion 210 and the cleaning portion 220 are fixed together and made of, for example, polypropylene, integrally. The handhold portion 210 is a rectangular block with rounded corners. The loading body 221 is a flat board. The thickness of the handhold portion 210 is significantly larger than that of the loading body 221. The loading body 221 is a rectangular structure. The first end 223 of the loading body 221 is perpendicularly fixed with a lateral side 211 of the handhold portion 210 and is parallel to a handhold surface of the handhold portion 210. The window cleaning sheet 222 is fixed on a first surface of the loading body 221. The window cleaning sheet 222 is a soft cleaning cloth which is slightly smaller than the first surface of the loading body 221 and fixed near the second end 224 of the loading body 221. The window cleaning sheet 222 is adhered to the surface of the first end of the loading body 221. The thickness of the cleaning portion 220 is significantly larger than that of a general document. Therefore, the loading body 221 of the cleaning portion 220 is designed to be a wedge whose thickness tapers off from the first end 223 to the second end 224.

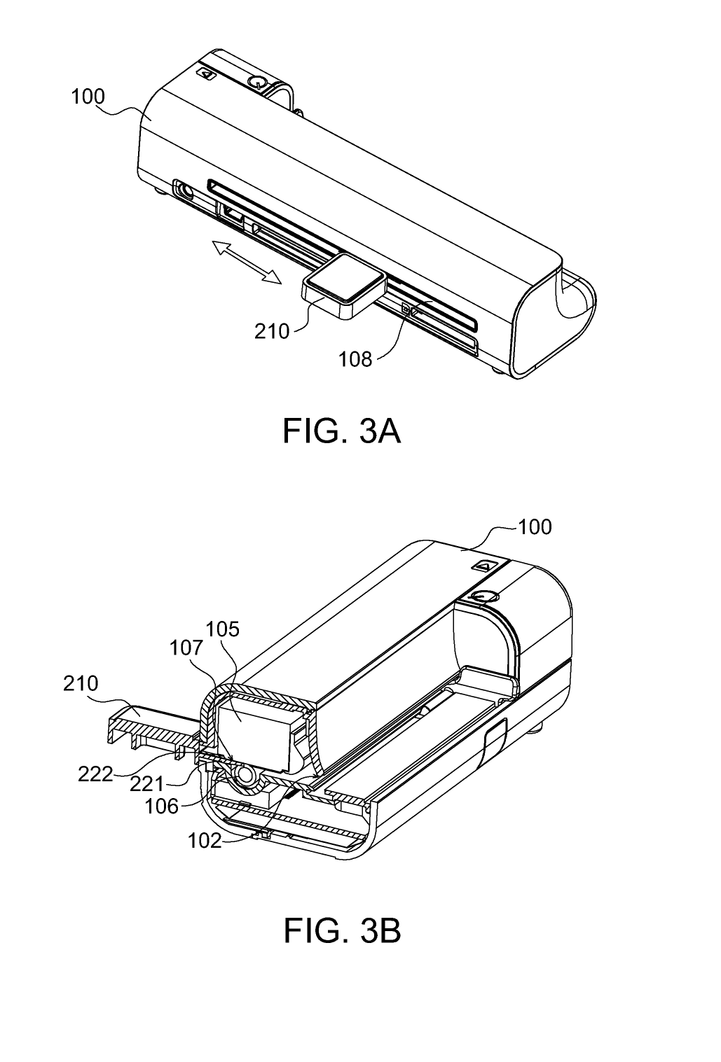

FIG. 3A Illustrates the cleaning device 20 applied to a scanner. FIG. 3B is a cross-sectional view of the scanner and the cleaning device 20 in FIG. 3A. The scanner is a compact portable scanner. The CIS scanning module 105 is immovable relative to the housing 100. The length of the cleaning portion 220, namely, the distance between the first end 223 and the second end 224, of the cleaning device 20 is substantially the same as the distance from the paper outlet 108 and the most inner part of the glass window 107 of the scanning module 105 of the scanner. The cleaning portion 220 of the cleaning device 20 is inserted into the paper outlet 108 of the scanner along the feeding direction of the documents. The CIS scanning module 105 is capable of moving vertically to make surface contact with the cleaning portion 220. The window cleaning sheet 222 on the first surface of the loading body 221 is positioned under the glass window 107 of the CIS scanning module 105 and contacts the glass window 107. The thickness of the handhold portion 210 is larger than that of the height of the paper outlet 108 of the scanner. Therefore, the lateral side 211 (shown in FIG. 2) of the handhold portion 210 contacts the outer edge of the paper outlet 108, which prevents the user from applying too much force and damaging the inner components due to pushing the cleaning portion 220 too far. As shown in FIG. 3A, the user holds the handhold portion 210 of the cleaning device 20 and moves it back and forth along the extending direction of the glass window 107 of the CIS scanning module 105. The window cleaning sheet 222 of the cleaning portion 220 contacts and wipes the glass window 107 laterally, so that the entire glass window 107 is cleaned thoroughly.

As shown in FIG. 3B, when the cleaning portion 220 cleans the glass window 107, the roller 106 contacts a second surface, which is opposite to the first surface, of the loading body 221. A roller cleaning sheet is preferably fixed on the contacting area. As soon as the scanner is turned on, the roller cleaning sheet cleans the rolling roller 106.

In the present embodiment, the size, thickness and shape of the handhold portion 210 and the cleaning portion 220 of the cleaning device 20 are decided according to the size of the scanner to be cleaned. The cleaning portion 220 should be able to be inserted into the paper inlet 102 or the paper outlet 108 and contact the glass window 107 of the CIS scanning module 105. Also, the cleaning device 20 preferably has compact size. It is easier to laterally move the cleaning portion 220 of the cleaning device 20 having small width, which provides better cleaning performance. The window cleaning sheet can be replaced depending on the practical conditions.

### Second Embodiment

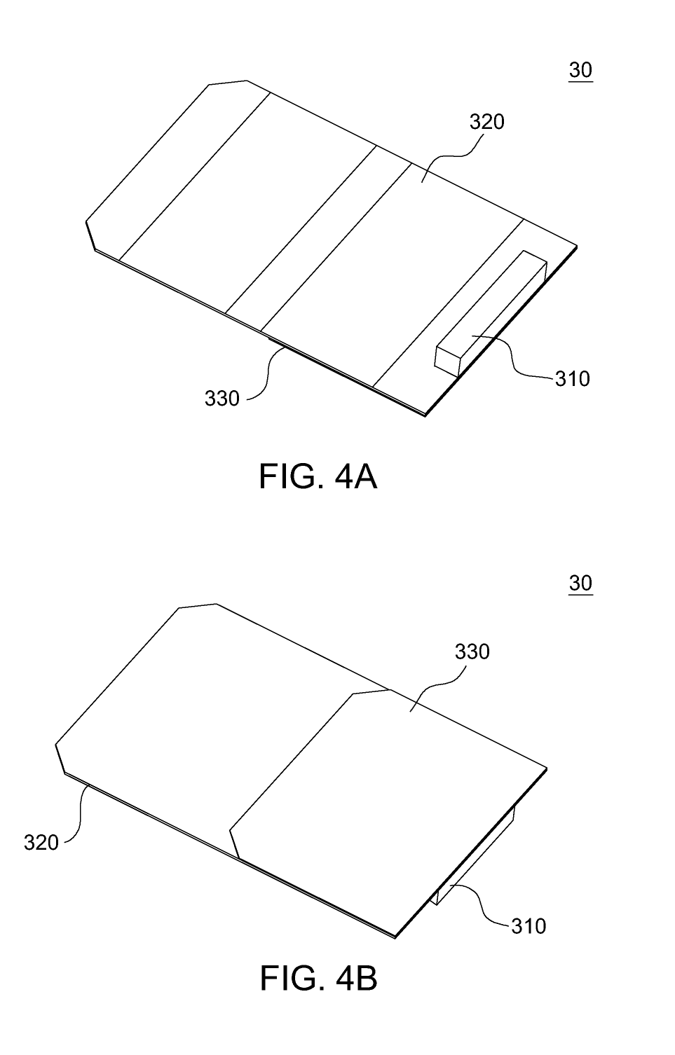

Please refer to FIG. 4A and FIG. 4B. FIG. 4A illustrates a cleaning device according to the second embodiment of the present invention. FIG. 4B is a rear view of the cleaning device 30 in FIG. 4A. The cleaning device 30 for scanner includes the handhold portion 310 and the cleaning portion. The cleaning portion is a soft sheet. The handhold portion 310 is a hard plastic block fixed on the upper surface of the cleaning portion. The upper surface of the cleaning portion is a soft window cleaning sheet 320 which is a soft cleaning cloth. The thickness of the cleaning cloth is greater than a general document. The handhold portion 310 is fixed on one end of the soft window cleaning sheet 320, and a roller cleaning sheet 330 is fixed on the back of the soft window cleaning sheet 320. The roller cleaning sheet 330 is preferably a soft cleaning cloth as well. The back of the roller cleaning sheet 330 is adhered to the back of the soft window cleaning sheet 320 to form the cleaning portion. The length of the roller cleaning sheet 330 is less than that of the soft window cleaning sheet 320.

The cleaning device 30 can further include a base. The soft window cleaning sheet 320 and the roller cleaning sheet 330 are adhered to both surfaces of the base to form the cleaning portion.

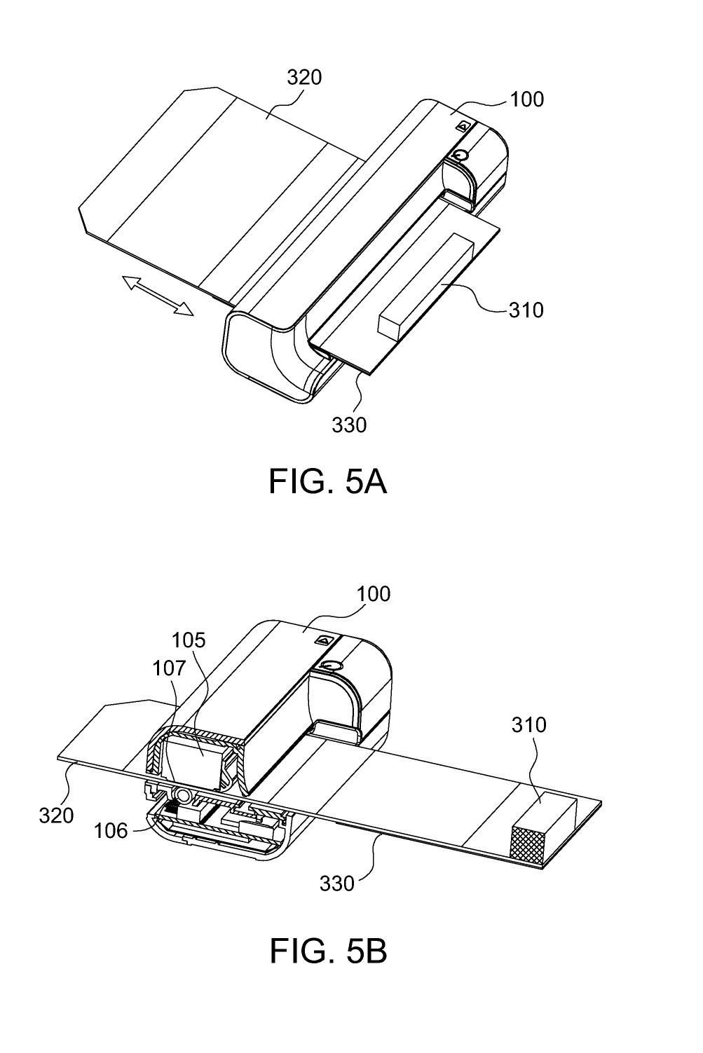

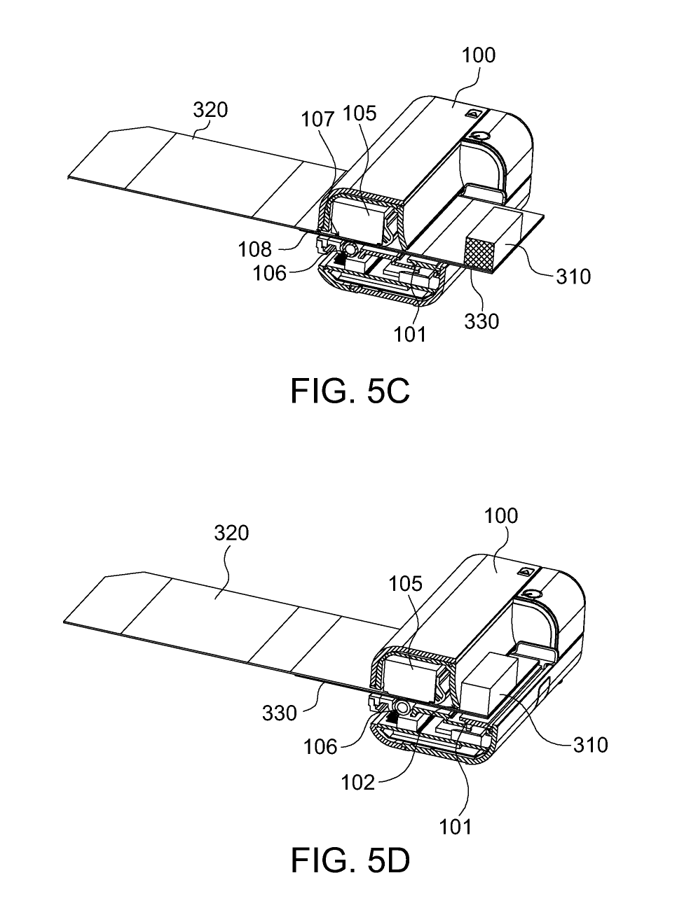

FIGS. 5A˜5D illustrate the cleaning device 30 according to the second embodiment of the present invention in operating states. FIG. 5A illustrates the cleaning device 30 in use. The CIS scanning module 105 is immovable relative to the housing 100 when performs scanning. The width of the soft window cleaning sheet 320 of the cleaning device 30 is substantially the same as that of the maximum scanning width of the scanner. The scanner performs the cleaning preferably according to a cleaning program predetermined on the scanner or directly according to a scanning program. One end of the soft window cleaning sheet 320 is placed on the document tray 101 and inserted into the paper inlet 102. The handhold portion 310 and the roller cleaning sheet 330 are on the other end of the soft window cleaning sheet 320. The cleaning program can set the operation of the soft window cleaning sheet 320 to be reciprocating transmission. As a result, the soft window cleaning sheet 320 cleans the glass window 107 repeatedly.

FIG. 5B is a cross-sectional view of the cleaning device 30 in the initial state of the cleaning process. The length of the soft window cleaning sheet 320 is larger than the distance between the paper inlet 102 and the paper outlet 108 of the scanner. The soft window cleaning sheet 320 enters the scanner through the paper inlet 102 along the same direction as the feeding direction of the documents. After driven by the roller 106, the soft window cleaning sheet 320 contacts the glass window 107 of the CIS scanning module 105 and then exits through the paper outlet 108. Through the connected elastic components, the CIS scanning module 105 is able to move vertically according to the thickness of the fed document. In this state, the soft window cleaning sheet 320 of the cleaning device 30 cleans the glass window 107. Because the length of the roller cleaning sheet 330 is less than that of the soft window cleaning sheet 320, the roller cleaning sheet 330 can not reach and clean the roller 106 in this state.

FIG. 5C is a cross-sectional view of the cleaning device 30 in the second state of the cleaning process. The soft window cleaning sheet 320 moves continuously toward the paper outlet 108 as the roller 106 rotates. The roller cleaning sheet 330 begins to contact the roller 106. The handhold portion 310 is on the side near the paper inlet 102. However, the roller cleaning sheet 330 can not clean the roller 106 because the soft window cleaning sheet 320 moves continuously under the rotation of the roller 106. Meanwhile, the soft window cleaning sheet 320 keeps cleaning the glass window 107.

FIG. 5D is a cross-sectional view of the cleaning device 30 in the third state of the cleaning process. The soft window cleaning sheet 320 and the roller cleaning sheet 330 move toward the paper outlet 108 to the furthest end under the rotation of the roller 106. Because the thickness of the handhold portion 310 is larger than that of the paper inlet 102, the handhold portion 310 is leant against the housing 100 of the scanner at the paper inlet 102. Thus, the soft window cleaning sheet 320 can not keep moving due to the block of the handhold portion 310. At this moment, the roller 106 contacts the roller cleaning sheet 330 sufficiently, and the roller 106 rotates relative to the roller cleaning sheet 330, so that the roller cleaning sheet 330 cleans the surface of the roller 106. When the cleaning process is completed, the mechanical transmission system of the scanner is reversed to move the cleaning device 30 out from the paper inlet 102.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A cleaning device for scanner, the cleaning device comprising:
a handhold portion; and
a cleaning portion comprising a window cleaning surface;
wherein the handhold portion and the cleaning portion are fixed together, and the thickness of the handhold portion is larger than that of the cleaning portion.

2. The device according to claim 1, wherein the handhold portion is connected with one end of the cleaning portion, the cleaning portion further comprises:
a loading body, being a hard or flexible flat board having a first end and a second end, the first end of the loading body fixed with the handhold portion; and
a window cleaning sheet, fixed on the loading body to form the window cleaning surface, the length of the window cleaning sheet equal to or larger than the distance between a paper inlet or a paper outlet of the scanner and a glass window of the scanner.

3. The device according to claim 2, wherein the window cleaning sheet comprises at least one of a soft cleaning cloth, a cleaning swab and a cleaning fiber.

4. The device according to claim 2, wherein the window cleaning sheet is a planar cleaning object adhered to a surface of the loading body.

5. The device according to claim 2, wherein the window cleaning sheet is a soft sleeve-shaped cleaning cloth or cleaning swab, and the window cleaning sheet surrounds the second end of the loading body and is fixed with the loading body.

6. The device according to claim 2, wherein the thickness of the loading body decreases from the first end to the second end, the thickness of the first end is greater than that of the second end.

7. The device according to claim 2, wherein the window cleaning sheet is disposed immovably on a first surface of the loading body, a roller cleansing sheet is disposed immovably on a second surface of the loading body, and the first surface and the second surface are opposite to each other.

8. The device according to claim 2, wherein the handhold portion is a hard holding block.

9. The device according to claim 2, wherein the first end of the loading body is vertically fixed with a lateral side surface of the handhold portion.

10. The device according to claim 2, wherein the thickness of the handhold portion is greater than the height of the paper inlet or the paper outlet of the scanner.

11. The device according to claim 1, wherein the handhold portion is fixed on one end of the cleaning portion, the cleaning portion comprises a soft window cleaning sheet, and the window cleaning surface is on one surface of the soft window cleaning sheet.

12. The device according to claim 11, wherein the cleaning portion further comprises a soft base, the soft window cleaning sheet is disposed immovably on the upper surface of the soft base.

13. The device according to claim 11, wherein the cleaning portion further comprises a roller cleaning sheet fixed on the back of the soft window cleaning sheet.

14. The device according to claim 13, wherein the length of the roller cleaning sheet is less than that of the soft window cleaning sheet.

15. The device according to claim 13, wherein the roller cleaning sheet is disposed near the handhold portion.
